(19) United States
(12) Patent Application Publication
(10) Pub. No.: US 2015/0098622 A1
(43) Pub. Date: Apr. 9, 2015

(54) IMAGE PROCESSING METHOD AND SYSTEM OF AROUND VIEW MONITORING SYSTEM

(71) Applicant: Hyundai Motor Company, Seoul (KR)

(72) Inventors: Seong Sook Ryu, Seoul (KR); Jae Seob Choi, Gyeonggi-do (KR); Eu Gene Chang, Gyeonggi-do (KR)

(73) Assignee: HYUNDAI MOTOR COMPANY, Seoul (KR)

(21) Appl. No.: 14/132,445

(22) Filed: Dec. 18, 2013

(30) Foreign Application Priority Data
Oct. 8, 2013 (KR) 10-2013-0119732

(51) Int. Cl. G06K 9/00; B60R 1/00

(52) U.S. Cl. CPC G06K 9/00791; B60R 1/00; B60R 2300/607
USPC 382/104

(57) ABSTRACT

An image processing method and system of an AVM system are provided. The method includes photographing, by a controller, an environment around a vehicle to generate a top view image and creating a difference count map by comparing two top view images photographed at time intervals. Partial regions in the created difference count map are extracted and an object recognizing image is generated by continuously connecting the extracted regions of the difference count map. Accurate positions and shapes of objects positioned around the vehicle may be recognized, and more accurate information regarding the objects around the vehicle may be provided to a driver.

### CROSS-REFERENCE TO RELATED APPLICATION

This application is based on and claims priority from Korean Patent Application No. 10-2013-0119732, filed on, Oct. 8, 2013 in the Korean intellectual Property Office, the disclosure of which is incorporated herein in its entirety by reference.

### BACKGROUND

1. Field of the Invention

The present invention relates to an image processing method and system of an around view monitoring (AVM) system, and more particularly, to an image processing method and system of an AVM system that recognizes a position and a form of an object around a vehicle more accurately and provides the recognized position and form to a driver.

2. Description of the Prior Art

Generally, a visual field of a driver in a vehicle is mainly directed toward the front. Therefore, since visual fields of the left and the right and the rear of the driver are significantly covered by a vehicle body, they are very limited. Therefore, a visual field assisting unit (e.g., a side mirror, or the like) that includes a mirror to widen a visual field of the driver having a limited range has been generally used. Recently, technologies including an imaging device that photographs an image of the exterior of the vehicle and provides the photographed image to the driver have been developed.

In particular, an around view monitoring (AVM) system has been developed in which a plurality of imaging devices are installed around the vehicle to show omni-directional (e.g., 360 degrees) images around the vehicle. The AVM system combines images around the vehicle photographed by the plurality of imaging devices to provide a top view image of the vehicle, to thus display an obstacle around the vehicle and remove a blind spot.

However, in the top view image provided by the AVM system, a shape of an object, particularly, a three-dimensional object, around the vehicle based on photographing directions of the imaging devices may be distorted and shown. An object of which a photographing direction and distance are close based on a position of the imaging device is photographed to be similar to an actual shape. However, as a relative distance to the imaging device and an angle from the photographing direction increases, a shape of the three-dimensional object may be distorted. Therefore, an accurate position and shape of the obstacle around the vehicle may not be provided to the driver.

### SUMMARY

Accordingly, the present invention provides an image processing method and system of an around view monitoring (AVM) system that assists in more actually recognizing a three-dimensional object around a vehicle when a shape of the three-dimensional object is distorted and shown in a top view image provided to a driver via the AVM system.

In one aspect of the present invention, an image processing method of an AVM system may include: photographing, by an imaging device, an environment around a vehicle to generate a top view image; creating, by a controller, a difference count map by comparing two top view images generated at different times; extracting, by the controller, partial regions in the created difference count map; and generating, by the controller, an object recognizing image by continuously connecting the extracted regions of the difference count map to each other. The image processing method may further include: recognizing, by the controller, an object around the vehicle using the object recognizing image; and including the recognized object in the top view image and displaying, by the controller, the top view image that includes the recognized object.

The creating of the difference count map may include: correcting, by a controller, a relative position change of an object around the vehicle included in the two top view images based on a movement of the vehicle; and comparing, by the controller, the two top view images in which the position change is corrected to calculate difference values for each pixel. The extracted region may include pixels having a number that corresponds to a movement distance of the vehicle in a movement direction of the vehicle in the difference count map. The extracted region may include a preset number of pixels in a movement direction of the vehicle in the difference count map.

In the generation of the object recognizing image, the extracted regions of the difference count map may be connected to be in proportion to a movement distance of the vehicle, and a final value may be determined based on weighting factors imparted to each pixel with respect to an overlapped pixel region. As an angle from a photographing direction of an imaging device based on a position of the imaging device in the difference count map increases, weighting factors to each pixel may decrease.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary block diagram illustrating a configuration of an around view monitoring (AVM) system according to an exemplary embodiment of the present invention;

FIG. 2 is an exemplary flow chart illustrating an image processing method of an AVM system according to the exemplary embodiment of the present invention;

FIGS. 3A and 3B are exemplary diagrams describing a process of generating a top view image according to the exemplary embodiment of the present invention;

FIGS. 4A and 4B are exemplary diagrams describing a process of creating a difference count map according to the exemplary embodiment of the present invention;

FIG. 5 is an exemplary diagram illustrating a difference count map created while time elapses according to an exemplary embodiment of the present invention;

FIG. 6 is an exemplary diagram describing a process of extracting a partial region in the difference count map according to the exemplary embodiment of the present invention;

FIG. 7 is an exemplary diagram describing a process of generating an object recognizing image according to the exemplary embodiment of the present invention; and

FIG. 8 is an exemplary diagram describing weighting factors imparted to each pixel of the difference count map according to an exemplary embodiment of the present invention; and

FIGS. 9A to 9C are exemplary diagrams describing a process of recognizing and displaying an object around a vehicle according to the exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/controlling unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/controlling unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

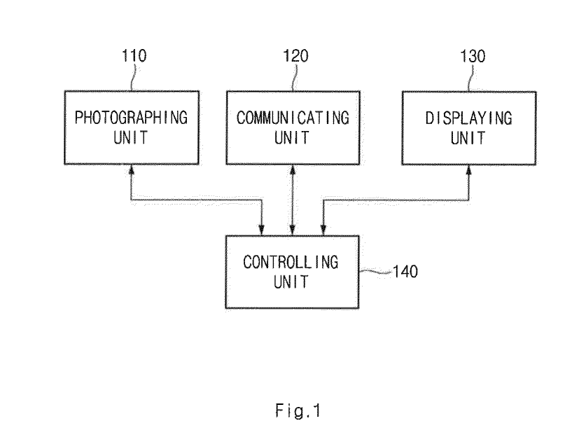

Hereinafter, the present invention will be described in detail with reference to the accompanying drawings. FIG. 1 is an exemplary block diagram illustrating a configuration of an around view monitoring (AVM) system according to an exemplary embodiment of the present invention. As illustrated in FIG. 1, the AVM system may include a photographing umt 110, a communicating unit 120, a displaying unit 130, and a controller 140. The controller 140 may be configured to operate the photographing unit 110, communicating unit 120, and the displaying unit 130.

The photographing unit 110 may be configured to photograph an environment around a vehicle. The photographing unit 110 may include a plurality of imaging devices (e.g., camera, video cameras, and the like) to omni-directionally (e.g., 360 degrees) photograph the environment around the vehicle. For example, the photographing unit 110 may include four imaging devices installed at the front, the rear, the left, and the right of the vehicle. In addition, the photographing unit 110 may include wide angle imaging devices configured to photograph the environment around the vehicle using a less number of imaging devices. The image around the vehicle photographed by the photographing unit 110 may be converted into a top view image as viewed from the top of the vehicle through image processing. The photographing unit 110 may be configured to continuously photograph the environment around the vehicle to continuously provide information regarding the environment around the vehicle to a driver.

The communicating unit 120 may be configured to receive various sensor values to process the top view image from electronic control units (ECUs) to adjust the respective portions of the vehicle. For example, the communicating unit 120 may be configured to receive a steering angle sensor value and a wheel speed sensor value to sense a movement distance and a movement direction of the vehicle. The communicating unit 120 may use a controller area network (CAN) communication to receive the sensor values of the ECUs. The CAN communication, which is a standard communication protocol designed for microcontrollers or apparatuses to communicate without a host computer in the vehicle, is a communication scheme in which a plurality of ECUs are connected in parallel to exchange information between the respective ECUs.

The displaying unit 130 may be configured to display the top view image generated by the controller 140. The displaying unit 130 may be configured to display the top view image in which the virtual image is include according to an object recognizing result. The displaying unit 130 may include various display devices such as a cathode ray tube (CRT), a liquid crystal display (LCD), an organic light emitting diode (OLED) and a plasma display panel (PDP), and the like. Additionally, the controller 140 may be configured to operate the AVM system. More specifically, the controller 140 may be configured to combine images around the vehicle photographed by the photographing unit 110 to generate the top view image.

Furthermore, the controller 140 may be configured to compare two top view images generated at different times to create a difference count map. The difference count map may be an image that indicates a difference value between corresponding pixels among pixels included in the two top view images generated at different time periods and may have different values for each pixel based on a degree thereof.

As described above, an object, particularly, a three-dimensional object, around the vehicle included in the top view image may be shown as a distorted shape. The difference count map may include information regarding the distorted three-dimensional object by comparing two continuous top view images and calculating difference values. In addition, the controller 140 may be configured to extract partial regions in the created difference count maps and continuously connect the extracted regions as time elapses to generate an object recognizing image. Further, the controller 140 may be configured to recognize the object around the vehicle using the generated object recognizing image. More specifically, the controller may be configured to recognize a shape of the object around the vehicle and a distance from the vehicle to the object around the vehicle using the object recognizing image. In addition, the controller 140 may be configured to compare the recognized shape of the object with pre-stored patterns and output a virtual image that corresponds to the recognized shape in the top view image when a pattern that corresponds to the recognized shape of the object is present.

Moreover, although not illustrated in FIG. 1, the AVM system according to the exemplary embodiment of the present invention ay further include a memory (not illustrated). The memory (not illustrated) maybe configured to store patterns and virtual images for shapes of objects. The controller 140 may be configured to compare the shape of the object shown in the object recognizing image and the patterns stored in the memory (not illustrated) and include a corresponding virtual image in the top view image when a pattern that corresponds the shape of the object is present. Therefore, a user may more actually receive a position and a shape of the object around the vehicle.

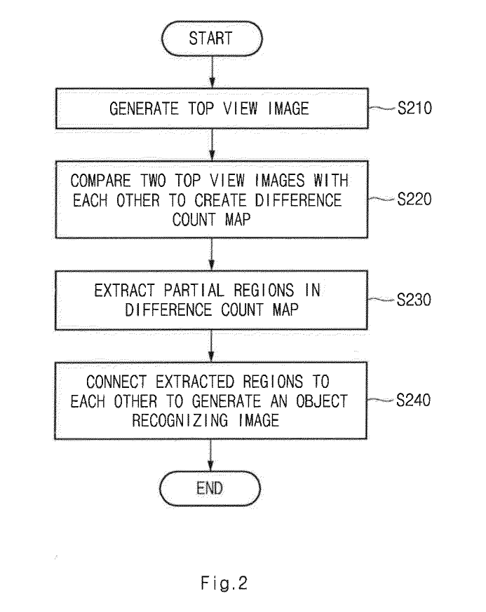

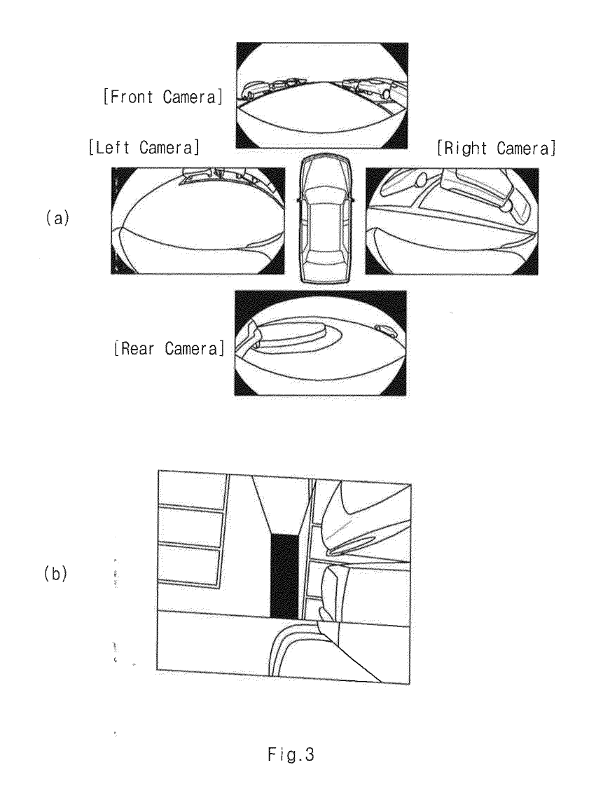

FIG. 2 is an exemplary flow chart illustrating an image processing method of an AVM system according to the exemplary embodiment of the present invention. Referring to FIG. 2, top view images may be generated (S210), and the generated top view images may be compared to create a difference count map (S220). Then, partial regions in the difference count maps may be extracted (S230), and the extracted regions may be connected to generate an object recognizing image (S240). Hereinafter, the respective operations will be described in detail with reference to FIGS. 3A to 9C.

First, the top view images may be generated (S210). More specifically, an environment around a vehicle may be omni-directionally (e.g., 360 degrees) photographed, and the photographed images may be combined to generate the top view images. This will be described in more detail with reference to FIG. 3.

FIGS. 3A and 3B are exemplary diagrams describing a process of generating a top view image according to the exemplary embodiment of the present invention. FIG. 3A illustrates images obtained by photographing an environment around a vehicle using a plurality of imaging devices. Particularly, FIGS. 3A and 3B illustrate the environment around the vehicle photographed using four imaging devices mounted at the front, the left, the right, and the rear of the vehicle, respectively. Although the four imaging devices as illustrated in FIG. 3A may be generally used to omni-directionally photograph the environment around the vehicle, it is merely an example. In other words, the environment around the vehicle may be photographed using any number of imaging devices.

FIG. 3B illustrates an exemplary top view image generated by combining the images photographed by the plurality of imaging devices. The image generated by photographing the environment around the vehicle may be converted into the top view image as seen from the top of the vehicle via image processing. Since a technology of processing the plurality of images generated by photographing the environment around the vehicle to convert the plurality of images into the top view image has been already known, a detailed description thereof will be omitted.

Furthermore, referring to FIG. 3B, shapes of other vehicles shown in the top view image may be distorted. As seen in FIG. 3B, shapes of three-dimensional objects shown in the top view image may be deformed radially based on a photographing direction of the imaging device. In other words, as an angle from the photographing direction of the imaging device increases, the shapes of the objects may be further distorted. Therefore, even though the top view image according to the current AVM system is output to a driver, the driver may not recognize accurate positions and shapes of objects around the vehicle due to the distortion. However, more accurate positions and shapes of objects around the vehicle may be recognized by processes to be described below.

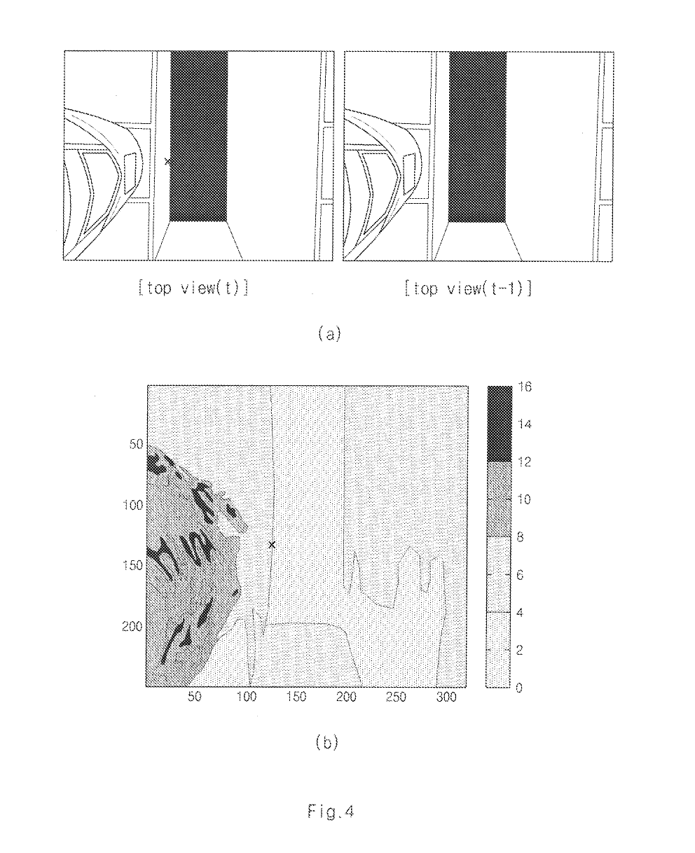

When the top view images are generated, two top view images generated at different time periods may be compared to create the difference count map (S220). As described above, the difference count map may be an image that indicates a difference value between corresponding pixels among pixels included in the two top view images generated at different time periods. The creation of the difference count map may include correcting, by the controller, a relative position change of the environment around the vehicle included in the two top view images based on movement of the vehicle and comparing, by the controller, the two top view images in which the position change is corrected to calculate difference values for each pixel. These processes will be described in detail with reference to FIGS. 4A and 4B.

FIGS. 4A and 4B are exemplary diagrams describing a process of creating a difference count map according to the exemplary embodiment of the present invention. Referring to FIG. 4A, a top view image [top view (t)] at a time t and a top view image [top view (t−1)] at a time t−1 at which a position change is corrected are illustrated.

The imaging device mounted within the vehicle may be configured to continuously photograph the environment around the vehicle at preset time intervals as the vehicle moves and generally photograph about 10 to 30 frames per second. In addition, the top view images may be continuously generated as time elapses using the images continuously photographed by the plurality of imaging devices. In particular, a change may be generated in positions of the objects around the vehicle included in the image between the respective top view images as the vehicle moves. When the difference count map is created, a relative position change of the object around the vehicle included in the other top view image may be corrected based on any one of the two temporally continuous top view images to remove (e.g., minimize) an error based on the movement of the vehicle. In FIG. 4A, a position of the top view image [top view (t−1)] that has been previously generated has been corrected based on the top view image [top view (t)] that is currently generated.

In particular, a corrosion degree of the top view image may be determined based on a movement distance and a movement direction of the vehicle. For example, when it is assumed that a distance of about 2 cm is represented by one pixel in the top view image, when the vehicle moves by about 10 cm in a forward direction during a time in which the two top view images are photographed, the past entire top view image may be moved by five pixels in an opposite direction to a movement direction of the vehicle based on the current top view image. Alternatively, the current entire top view image may be moved by five pixels in the movement direction of the vehicle based on the past top view image. In particular, the movement distance of the vehicle may be calculated by receiving a movement distance of electronic control units (ECUs) adjusting the respective portions of the vehicle and sensor values (e.g., a steering angle sensor value and a wheel speed sensor value) required to calculate a movement direction.

Further, the two top view images in which the position change based on the movement of the vehicle is corrected may be compared to create the difference count map. FIG. 4B illustrates an exemplary result of creating a difference count map using two top view images illustrated in FIG. 4A. The difference count map may be created using various algorithms that create a difference between two images a numeral value. For example, a census transform algorithm may be used. The census transform algorithm is a well-known technology. A process of creating a difference count map by the census transform algorithm will be schematically described. First, reference pixels positioned at the same position may be selected for the respective two images, and pixel values of the respective reference pixels and pixel values of adjacent pixels may be compared to calculate to difference values.

In particular, the number and the pattern of adjacent pixels may be selected by various methods. The difference count map illustrated in FIG. 4B illustrates the number of adjacent pixels set to 16. Then, in which of preset sections the difference value between the reference pixel and the adjacent pixels is included may be determined. The number and range of set sections may be variously set based on an accuracy level. When all of the sections in which the difference values between the reference and the adjacent pixels are included are determined, results of two images may be compared to count the number of different section values. The number of different section values may be calculated as a final difference value of the reference pixel. The final difference value may have a value of about 0 to 15 when the number of adjacent pixels is set to 16. In this scheme, final difference values may be calculated for all of the pixels to create a difference count map.

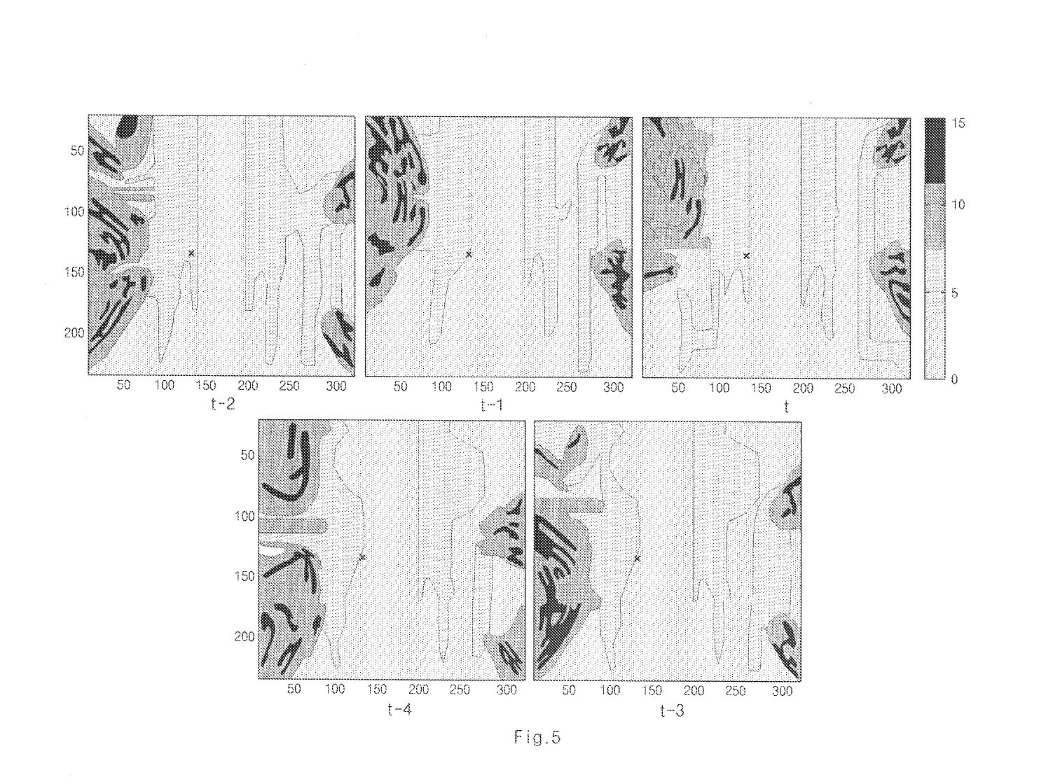

In particular, since the object, particularly, the three-dimensional object, around the vehicle included in the top view image is shown as the distorted shape, the difference count map may include information regarding the distorted and shown three-dimensional object by comparing two continuous top view images and calculating the difference values. Moreover, when a new top view image is generated, the new top view image may be compared with the previous top view image to create a difference count map. This will be described with reference to FIG. 5.

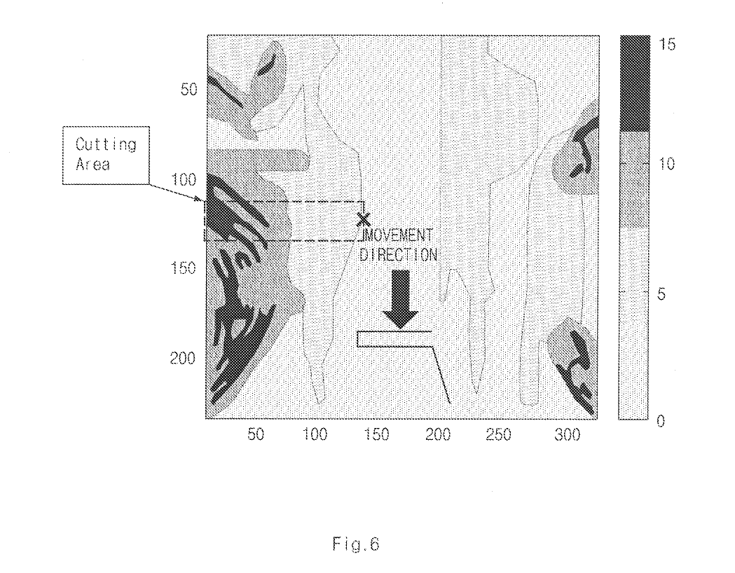

FIG. 5 is an exemplary diagram illustrating a difference count map created while time elapses. FIG. 5 illustrates an exemplary difference count map created from the past point in time t−4 to a current point in time t. Referring to FIG. 5, it may be appreciated that positions of three-dimensional objects around a vehicle shown in the difference count map may move as the vehicle moves. Then, a partial region in the created difference count map may be extracted (S230). As described above, the information regarding the positions and the shapes of the three-dimensional object around the vehicle may be included in the difference count map. A specific region having high reliability in the difference count map may be extracted to increase accuracy of object recognition. This will be described with reference to FIG. 6.

FIG. 6 is an exemplary diagram describing a process of extracting a partial region in the difference count map according to the exemplary embodiment of the present invention. Referring to FIG. 6, a rectangular region including a photographing direction (e.g., right direction based on a movement direction of the vehicle) of an imaging device may be extracted based on a position (marker x) of the imaging device that photographs the right side of the vehicle. As described above, as an angle from the photographing direction based on the position of the imaging device increases, the photographed object may be distorted. Therefore, when the angle from the photographing direction of the imaging device increases, information regarding the three-dimensional object of which the shape is distorted may be included in the difference count map. Therefore, a region adjacent to the photographing direction of the imaging device based on the position of the imaging device may be extracted to exclude the information regarding the distorted three-dimensional object and obtain more reliable information.

Moreover, the number of pixels in the movement direction of the vehicle in the region extracted in the difference count map may be determined based on a movement speed of the vehicle. The regions each extracted in continuously created difference count maps may be connected as time elapses as described below. In particular, when a region that includes pixels having a number less than a movement distance of the vehicle is extracted, a discontinuous region may appear. Therefore, a sufficient region may be extracted in consideration of the movement distance of the vehicle. As an example, the extracted region may include a preset number of pixels in the movement direction of the vehicle in the difference count map.

The AVM system may be mainly used when the vehicle is parked or the vehicle passes through a narrow road in which an obstacle is present. The preset number of pixels may be determined based on a maximum movement speed of the vehicle. More specifically, the preset number of pixels may be set to be equal to or greater than the number of pixels in which the vehicle maximally moves in the image based on the maximum movement speed of the vehicle. The number of pixels required according to the maximum movement speed of the vehicle may be represented by the following Equation 1.

$$X = \frac{V}{F \times D} \qquad Equation 1$$

wherein X is the preset number of pixels, V is the maximum movement speed of the vehicle, F is an image photographing speed, and D is an actual distance per pixel. More specifically, X is the number of pixels to be extracted in the movement direction of the vehicle in one difference count map and has a unit of px/f. The maximum speed V of the vehicle, may be a maximum movement speed of the vehicle and has a unit of cm/s. The image photographing speed F may be the number of image frames photographed by the imaging device per second and has a unit of f/s. The actual distance D per pixel, which may be an actual distance that corresponds to one pixel of the difference count map, has a unit of cm/px. The image photographing speed F and the actual distance D per pixel may be changed based on performance or a setting state of the imaging device.

For example, when the maximum movement speed of the vehicle is about 36 km/h, the image photographing speed may be about 20 f/s, and the actual distance per pixel may be about 2 cm/px, since the maximum movement speed (e.g., 36 km/h) of the vehicle may correspond to about 1000 cm/s, when these values are substituted into the above Equation 1, the preset number X of pixels may be about 25 px/f. In other words, a region of about 25 pixels or more in the movement direction of the vehicle in the difference count map may be extracted. As another example, the extracted region may include pixels having a number that corresponds to a movement distance of the vehicle in the movement direction of the vehicle in the difference count map. For example, when it is assumed that a distance of about 2 cm is shown as one pixel in the top view image and when the vehicle moves by about 20 cm in a forward direction for a time in which two top view images are photographed, a region that includes about 10 pixels in the movement direction of the vehicle may be extracted. Alternatively, when vehicle moves by about 30 cm in the forward direction, a region that includes about 15 pixels in the movement direction of the vehicle may be extracted.

In particular, as described above with reference to FIGS. 4A and 4B, the movement distance of the vehicle may be calculated by receiving a movement distance of ECUs adjusting the respective portions of the vehicle and sensor values (e.g., a steering angle sensor value and a wheel speed sensor value) required for calculating a movement direction. Although the extracted rectangular region has been described with reference to FIG. 6, this is merely an example. In other words, a region having any shape in which a discontinuous region does not appear when extracted regions are connected, such as a trapezoidal shape, or the like, may be extracted. In addition, although only a method of extracting a right region based on the movement direction of the vehicle has been described with reference to FIG. 6, a method of extracting a left region may be similarly applied.

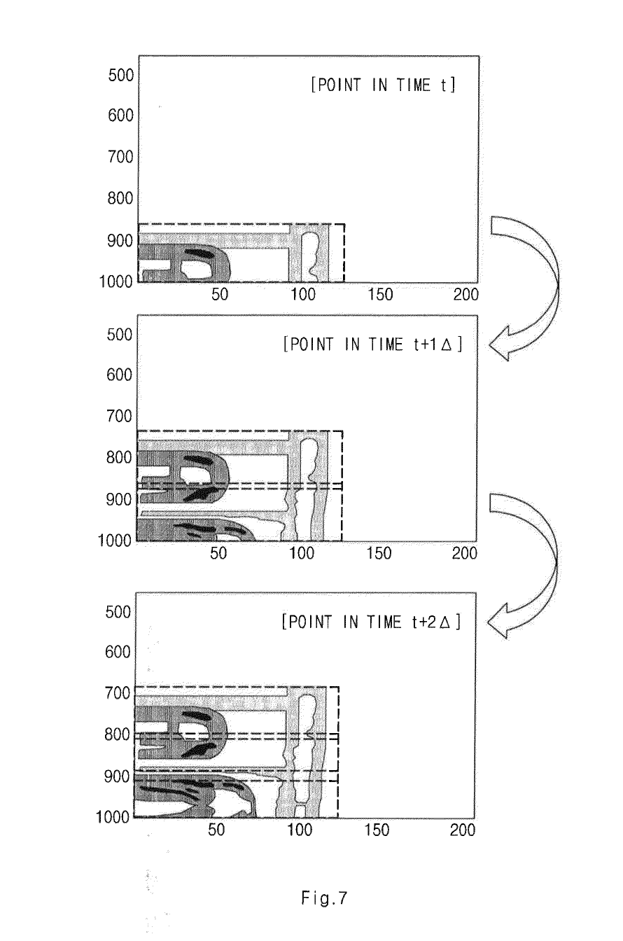

Furthermore, the extracted regions of the difference count maps may be continuously connected as time elapses to generate the object recognizing image (S240). Since the generating of the object recognizing image in the movement direction of the vehicle may be changed based on a scheme of extracting partial regions in the difference count maps, examples will be described, respectively. As an example, the extracted region may include a preset number of pixels in the movement direction of the vehicle in the difference count map. In particular, since preset regions may be extracted when the difference count maps are created without the movement distance of the vehicle, when the extracted regions are connected, an error may occur between the connected extracted regions and an actual movement distance of the vehicle. Therefore, when the extracted regions include a preset number of pixels, the regions may be connected to correspond to the movement distance of the vehicle in the movement direction of the vehicle. This will be described in detail with reference to FIG. 7.

FIG. 7 is an exemplary diagram describing a process of generating an object recognizing image according to the exemplary embodiment of the present invention. Referring to FIG. 7, the extracted regions may be connected as time elapses from an initial point in time t to a current point in time t+2 to generate the object recognizing image. In particular, although sizes of the extracted regions at each point in time are about the same, a new extracted region may be connected to the previous extracted regions to correspond to the movement distance of the vehicle in the movement direction of the vehicle when the new extracted region is connected to the previous extracted regions, to generate overlapped regions.

A final pixel value may be determined by various methods such as a method of giving a priority to a new extracted region, a method of selecting an intermediate value of pixel values of each extracted region, a method of selecting any one pixel value based on weighting factors imparted to each pixel, a method of determining a pixel value by setting a contribution based on weighting factors imparted to each pixel, and the like, with respect to the overlapped region. When the contribution based on the weighting factors imparted to each pixel are set, a final pixel value may be determined by the following Equation 2. The following Equation 2 is an equation for determining a final pixel value when n extracted regions are overlapped with respect to one pixel to be shown in the object recognizing image.

$${p}_{f} = \frac{( {p}_{1} \times {w}_{1} ) + ( {p}_{2} \times {w}_{2} ) + … + ( {p}_{n} \times {w}_{n} )}{{w}_{1} + {w}_{2} + … + {w}_{n}} \qquad Equation 2$$

wherein, p_{f} is a final pixel value, p₁ is a pixel value of a first extracted region, p₂ is a pixel value of a second extracted region, pₙ is a pixel value of a n-th extracted region, w₁ is a weighting factor imparted to a pixel of the first extracted region, w₂ is a weighting factor imparted to a pixel of the second extracted region, and wₙ is a weighting factor imparted to a pixel of the n-th extracted region.

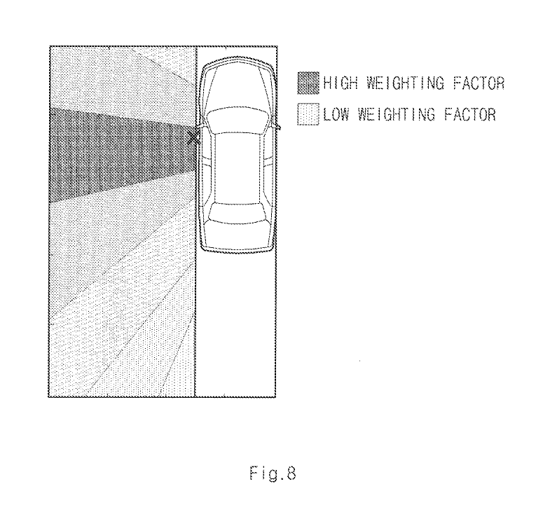

Moreover, weighting factors imparted to each pixel will be described with reference to FIG. 8. FIG. 8 is an exemplary diagram describing weighting factors imparted to each pixel of the difference count map. Referring to FIG. 8, different weighting factors may be imparted to each pixel of the difference count map. The weighting factors may be determined by reliability of pixel values of each pixel. As described above, as the angle from the photographing direction based on the position (marker x) of the imaging device increases, the photographed object may be distorted. Therefore, as the angle from the photographing direction increases, reliability of the pixel values included in the difference count map may be decreased. Therefore, as illustrated in FIG. 8, a substantially high weighting factor may be imparted to pixels having a substantially small angle from the photographing direction based on the position of the imaging device, and a substantially low weighting factor may be imparted to pixels having a substantially large angle from the photographing direction based on the position of the imaging device.

As another example, when the extracted regions include pixels having a number that corresponds to the movement distance of the vehicle in the movement direction of the vehicle in the difference count map will be described. When the extracted regions correspond to the movement distance of the vehicle, the extracted regions may be connected in the movement direction of the vehicle without overlapped regions whenever the difference count maps are created to generate the object recognizing image. In particular, the object recognizing image may be generated since the movement distance of the vehicle has been already considered when the partial regions are extracted in the difference value maps.

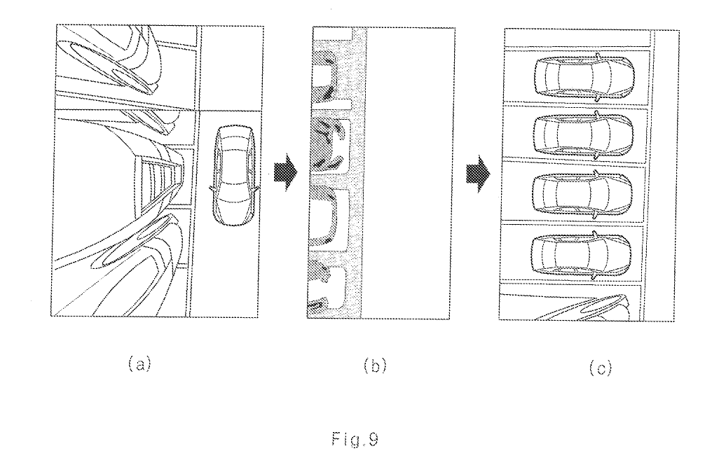

According to the examples as described above, as the vehicle moves, a new difference count map may be created, and when the difference count map is created, a new extracted region may be updated, thus information regarding the object around the vehicle changed based on the movement of the vehicle may be reflected. Additionally, although not illustrated in FIG. 2, in the image processing method of an AVM system according to the exemplary embodiment of the present invention, the object around the vehicle may be recognized using the object recognizing image, and the recognized object may be included and displayed in the top view image. This will be described with reference to FIG. 9.

FIGS. 9A to 9C are exemplary diagrams describing a process of recognizing and displaying an object around a vehicle according to the exemplary embodiment of the present invention. FIG. 9A illustrates a general top view image. Referring to FIG. 9A, shapes of three-dimensional objects around the vehicle may be distorted, such that accurate shapes and positions may not be recognized. In addition, FIG. 9B illustrates an exemplary object recognizing image generated by processing a top view image according to the exemplary embodiment of the present invention. Referring to FIG. 9B, information regarding three-dimensional objects around the vehicle may be included in the object recognizing image. Therefore, more accurate positions, distances, and shapes of the three-dimensional objects around the vehicle may be recognized using the object recognizing image. In addition, the shapes of the three-dimensional objects shown in the object recognizing image may be compared with pre-stored patterns and virtual images that correspond to the shapes may be shown in the top view image when patterns that correspond to the shapes are present. FIG. 9C illustrates when the three-dimensional objects around the vehicle are determined to be vehicles to dispose virtual images of vehicle shapes at corresponding positions. When comparing FIG. 9C with FIG. 9A, positions, distances, and shapes of the three-dimensional objects around the vehicle may be more accurately recognized.

Moreover, the image processing method of an AVM system according to various exemplary embodiments of the present invention may be implemented by programs that may be executed in a terminal apparatus. In addition, these programs may be stored and used in various types of recording media. More specifically, codes for performing the above-mentioned methods may be stored in various types of non-volatile recording media such as a flash memory, a read only memory (ROM), an erasable programmable ROM (EPROM), an electronically erasable and programmable ROM (EEPROM), a hard disk, a removable disk, a memory card, a universal serial bus (USB) memory, a compact disk (CD) ROM, and the like. According to various exemplary embodiments of the present invention as described above, the AVM system may recognize more accurate positions and shapes of objects positioned around the vehicle and provide more accurate information regarding the objects around the vehicle to a driver.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. An image processing method of an around view monitoring (AVM) system, comprising:
photographing, by a controller, an environment around a vehicle to generate a top view image;
creating, by the controller, a difference count map by comparing two top view images photographed at different time intervals;
extracting, by the controller, partial regions in the created difference count map; and
generating, by the controller, an object recognizing image by continuously connecting the extracted regions of the difference count map.

2. The image processing method according to claim 1, further comprising:
recognizing, by the controller, an object around the vehicle using the object recognizing image; and
including, by the controller, the recognized object in the top view image and displaying the top view image that includes the recognized object.

3. The image processing method according to claim 1, wherein the creating of the difference count map includes:
correcting, by the controller, a relative position change of an object around the vehicle included in the two top view images based on movement of the vehicle; and
comparing, by the controller, the two top view images in which the position change is corrected to calculate difference values for each pixel.

4. The image processing method according to claim 1, wherein the extracted region includes pixels having a number that corresponds to a movement distance of the vehicle in a movement direction of the vehicle in the difference count map.

5. The image processing method according to claim 1, wherein the extracted region includes a preset number of pixels in a movement direction of the vehicle in the difference count map.

6. The image processing method according to claim 5, wherein in generating of the object recognizing image, the extracted regions of the difference count map are connected to be in proportion to the movement distance of the vehicle, and a final value is determined based on weighting factors imparted to each pixel with respect to an overlapped pixel region.

7. The image processing method according to claim 5, wherein as an angle from a photographing direction of an imaging device based on a position of the imaging device in the difference count map increases, weighting factors to each pixel decrease.

8. The image processing method according to claim 1, wherein the controller is configured to operate an imaging device to photograph the environment around the vehicle.

9. An image processing system of an around view monitoring (AVM) system, comprising:
a memory configured to store program instructions; and
a processor configured to execute the program instructions, the program instructions when executed configured to:
photograph an environment around a vehicle to generate a top view image;
create a difference count map by comparing two top view images photographed at different time intervals;
extract partial regions in the created difference count map; and
generate an object recognizing image by continuously connecting the extracted regions of the difference count map.

10. The system according to claim 9, wherein the program instructions when executed are further configured to:
recognize an object around the vehicle using the object recognizing image; and
include the recognized object in the top view image and displaying the top view image includes the recognized object.

11. The system according to claim 9, wherein the program instructions when executed are further configured to:
correct a relative position change of an object around the vehicle included in the two top view images based on movement of the vehicle; and
compare the two top view images in which the position change is corrected to calculate difference values for each pixel.

12. The system according to claim 9, wherein the extracted region includes pixels having a number that corresponds to a movement distance of the vehicle in a movement direction of the vehicle in the difference count map.

13. The system according to claim 9, wherein the extracted region includes a preset number of pixels in a movement direction of the vehicle in the difference count map.

14. A non-transitory computer readable medium containing program instructions executed by a controller, the computer readable medium comprising:
program instructions that control an imaging device to photograph an environment around a vehicle to generate a top view image;
program instructions that create a difference count map by comparing two top view images photographed at different time intervals;
program instructions that extract partial regions in the created difference count map; and
program instructions that generate an object recognizing image by continuously connecting the extracted regions of the difference count map.

15. The non-transitory computer readable medium of claim 14, further comprising:
program instructions that recognize an object around the vehicle using the object recognizing image; and
program instructions that include the recognized object in the top view image and displaying the top view image that includes the recognized object.

16. The non-transitory computer readable medium of claim 14, further comprising:
program instructions that correct a relative position change of an object around the vehicle included in the two top view images based on movement of the vehicle; and
program instructions that compare the two top view images in which the position change is corrected to calculate difference values for each pixel.

17. The non-transitory computer readable medium of claim 14, wherein the extracted region includes pixels having a number that corresponds to a movement distance of the vehicle in a movement direction of the vehicle in the difference count map.

18. The non-transitory computer readable medium of claim 14, wherein the extracted region includes a preset number of pixels in a movement direction of the vehicle in the difference count map.
